(19) United States
(12) Patent Application Publication
(10) Pub. No.: US 2024/0234728 A1
(43) Pub. Date: Jul. 11, 2024

(54) CARBON-LAYERED GRAIN-FREE SINGLE-CRYSTAL CATHODE PARTICLES AND METHOD FOR PREPARING SAME

(71) Applicant: UCHICAGO ARGONNE, LLC, Chicago, IL (US)

(72) Inventor: YoungHo Shin, LaGrange Highlands, IL (US)

(73) Assignee: UCHICAGO ARGONNE, LLC, Chicago, IL (US)

(21) Appl. No.: 18/095,408

(22) Filed: Jan. 10, 2023

(51) Int. Cl. H01M 4/587; H01M 4/04; H01M 4/62

(52) U.S. Cl. CPC H01M 4/587; H01M 4/0471; H01M 4/0492; H01M 4/625; H01M 2004/028

(57) ABSTRACT

The invention provides a cathode particle comprising a secondary particle comprised of primary particles sans lithium proximal to their surfaces, wherein each of the primary particles have embedded carbon layers or passageways. Also provided is a method for making a single crystal particle having embedded carbon layers, the method comprising dissolving metal salts and carbon stock in water to create a solution; mixing the solution with a lithium containing compound at a subcritical temperature of water to create a mixture of agglomerated particles; allowing the mixture to reach a hydrothermal reaction condition for a time to form carbon layered grain-free single crystal lithiated particles; removing surface lithium from the single crystal lithiated particles; drying the single crystal partially de-lithiated particles after washing and filtering; and heat-treating the particles after forming granulated secondary particles such that the secondary particles comprise a plurality of the primary particles physically contacting each other.

### CONTRACTUAL ORIGIN OF THE INVENTION

The U.S. Government has rights in this invention pursuant to Contract No. DE-AC02-06CH11357 between the U.S. Department of Energy and UChicago Argonne, LLC, representing Argonne National Laboratory.

### BACKGROUND OF THE INVENTION

### 1. Field of the Invention

This invention relates to cathodes for lithium batteries and more specifically, this invention relates to a cathode material and a method for making the material comprising carbon layered microstructures.

### 2. Background of the Invention

Lithium-ion batteries with high energy density and voltage, long lifespan, and low self-discharge rate continue to be sought after. Ni-rich compounds, Li[Ni₁₋ₓMₓ]O₂ (M=metal, x≤0.2), such as Li[Ni_{0.8}Mn_{0.1}Co_{0.1}]O₂ (NMC) and Li[Ni_{0.8}Co_{0.15}Al_{0.05}]O₂ (NCA), have been studied intensively for the past decade because of their relatively high energy density, reversible capacity, low toxicity, and low cost.

Recently however, cobalt/nickel-free cathode materials are attracting attention due to the rise in the price of cobalt and nickel. Among these cobalt/nickel-free cathode materials being considered is lithium iron phosphate (LiFePO₄, i.e., LFP), given its low cost and high safety.

Lithium-ion batteries have a limit in which their lifespan is rapidly reduced by repeating charging and discharging. This is because moisture or other factors in the battery can degrade the electrolyte, deteriorate the active material, or increase the internal resistance of the battery. Their poor cycling performance, thermal instability, and deteriorating calendar life are still important issues because of the increase in cell impedance during cycling at elevated temperatures.

Furthermore, the anisotropic volume change during lithium extraction/insertion makes polycrystalline cathode particles, currently used in lithium-ion batteries, vulnerable to grain-boundary (inter-granular) fracture. This fracture leads to rapid impedance growth and capacity decay. Polycrystalline cathode particles are agglomerations of primary particles, and as charging and discharging are repeated, fracture of the interface between primary particles occurs. Inter-granular fractures inside the polycrystalline cathode particle disrupt the electronic and ionic conduction pathway and dramatically increases particle surface area. This promotes unwanted surface-related degradation including surface phase transformation, transition metal dissolution, lattice oxygen release, and electrolyte decomposition.

Polycrystalline NMC cathode particles currently found in lithium-ion batteries are each an agglomeration of primary particles with respective grain boundaries. FIG. 1 comprises three micrographs of state of the art polycrystalline NMC cathode particles (via scanning electron microscopy, SEM). FIG. 1A shows the surface of the typical particle. FIG. 1B shows a cross section of that particle. FIG. 1C is a magnified image (via SEM) of that cross section. The SEM image shows numerous grains inside the polycrystalline NMC cathode particle. These grains cause rapid impedance growth and capacity decay due to cracks occurring along the grain boundaries during cycling of the lithium batteries.

To produce this polycrystalline NMC cathode material, nickel cobalt manganese hydroxide precursor, which is about 10˜30 microns in size, is prepared via a co-precipitation method. This nickel cobalt manganese hydroxide precursor material is mixed with a lithium source material and then calcined to be transformed into the polycrystalline NMC cathode material. (Calcination is defined as heating to high temperatures in air or oxygen.)

During this calcination process, lithium dissolves and permeates into the nickel cobalt manganese precursor particles. Due to the intrinsic mass transfer limitation of this solid-phase reaction, after calcination, excess/residual lithium remains on the surface of the cathode particles, and a relatively lower lithium concentration is formed inside these particles near their centers. The cathode particle does not have uniform lithium distribution due to the limitation of lithium mass transfer from outside the particle toward the particle center during calcination. The lithium is more abundant in the vicinity of the cathode particle surface than the particle core, which is the same issue for all kinds of cathode particles synthesized through solid-phase reaction during the calcination process by mixing precursor particles and lithium source particles.

The excess/residual lithium present on the surface of the polycrystalline NMC cathode particles thus formed reacts with moisture or CO₂ in the air to easily form surface impurities such as Li₂CO₃ and LiOH. These impurities react with the electrolyte and further cause undesirable by-products.

The presence of the impurities causes performance degradation such as the decrease in capacity and rate performance of the battery and serious safety problems such as gas generation and expansion inside the battery. Since the polycrystalline NMC cathode particle is a particle that is an agglomeration of primary particles, the undesirable lithium-containing impurities that may form on the surface of the primary particles (which form grain boundaries inside the polycrystalline cathode particle) cause an inherent problem of battery performance degradation.

In summary of this polycrystalline discussion, conventional polycrystalline cathode particles with a size of 10 to 30 microns inevitably form small primary particles with grain boundaries inside during the manufacturing process. Furthermore, the interior structure of these polycrystalline particles is broken and separated during battery cycling. The polycrystalline particles depicted in FIG. 1 are broken along the grain boundaries of the inner primary particles due to the stress generated during the charging/discharge cycles. This fracture causes the interior of the polycrystalline particles to become unconnected, resulting in impedance growth and capacity decay.

A need exists in the art for a process to manufacture a cathode particle that is not polycrystalline. The particle should prevent rapid impedance growth and capacity decay in polycrystalline cathode particles. Any resulting particle should be of a grain-free single-crystal structure that is resistant to fracture. The particle should be submicron in size (i.e., no more than 1 micron (μm) in diameter) and have physical contact with adjacent particles so as to enable faster lithium access to its core and to also facilitate lithium and electron transfers between small particles. Furthermore, the ideal particle should be without intergranular boundaries and residual lithium on the particle surface so as to mitigate impedance growth inside and outside the particle during charge-discharge cycles.

### SUMMARY OF INVENTION

An object of the invention is to provide a method for producing cathode particles that overcomes many of the drawbacks of the prior art.

Another object of the invention is to provide a method for producing cathode particles devoid of internal defects. A feature of the invention is the utilization of a continuous hydrothermal manufacturing method. An advantage of the invention is that internal void fractions and or grain boundaries within the particles are eliminated. This results in superior electrochemical performance compared to polycrystalline battery materials. Prior art polycrystalline particle structure can be construed as particles with internal grain boundaries. In contrast, the invented single crystal particle structure does not have internal grain boundary. So, while polycrystalline particles are internally cracked and disconnected during the charging and discharging process, the invented granulated secondary particle overcomes internal cracking and disconnection by being comprised of carbon-layered and linked single crystal particles.

Still another object of the invention is to provide cathode particles which do not have residual lithium on their surfaces. (“Residual lithium” is construed herein as products formed by reaction with electrolyte or air or water and not compounded with active cathode material. Exemplary impurities include Li₂CO₃, and LiOH. As such, residual lithium is not ionically or covalently bonded or otherwise crystallographically bonded with elements comprising the cathode. A feature of the invention is that the particles do not contain internal voids, grain boundaries or other defects. An advantage of the invention is that more lithium is concentrated at the center of the particles than at their surfaces.

Yet another object of the invention is to provide cathode particles with increased electronic conductivities. A feature of these particles is that they have internal discrete conductive passageways. An advantage of the invention is that the passageways optimize electronic and ionic transmission through the particles and through adjacent particles, thereby enhancing conductivity of cathodes comprising the particles.

Briefly, the invention provides a cathode particle comprising a secondary particle comprised of primary particles, wherein each of the primary particles have internal carbon layers or passageways. The “secondary” designation is utilized throughout this specification to designate the invented granulated particles.

The invention further provides a granulated secondary cathode particle comprising internal/external carbon layers and primary particles, wherein each of the primary particles has internal/external carbon layers or passageways. The granulated structure provides improved cycle life, high C-rate capability, and first cycle efficiency because of conductivity increases resulting from the additional conducting layers between the primary particles. Thus, a plurality of conduction layers are provided; for example a first layer formed in the primary particles and a second layer formed around these clustered primary particles during the agglomeration (i.e. granulation) process. The carbon layers are 3-dimensional nano-net carbon connections comprising localized carbon layers of primary particles and wide-area carbon linkages of secondary particles serving as electronic and ionic communication pathways with adjacent primary particles. “Nano” indicates the thickness of the carbon linkages and CNT linkages inside the granulated secondary particles.

Also provided is a method for making a single crystal particle having internal carbon layers, the method comprising dissolving metal salts and carbon stock in water to create a metal-containing solution; mixing the solution with a lithium containing compound (which may be in a solution) at a subcritical temperature of water to create a mixture of agglomerated particles; allowing the mixture to reach a hydrothermal reaction condition for a time to form carbon layered grain-free single crystal lithiated particles; removing lithium proximal to the particle's surface, drying the primary single crystal-partially de-lithiated-particles after washing and filtering; and heat-treating the dried particles. (Proximal to the particle's surface is construed herein as being within a few to tens of nanometers, e.g., within 5 to 100 nm, and more typically between 10 and 50 nm). The lithium removal process occurs at subcritical temperatures and supercritical pressure, as well as at ambient temperature and subcritical pressure, of water. In summary of this point, there is no residual lithium outside the surface of the particle (because it is washed away by water), and there is less lithium inside the surface of the particle than in the particle core (because it is partially dissolved by water.

The particles may then be heat treated (e.g., annealed) to form secondary particles such that the secondary particles comprise a plurality of primary particles.

### BRIEF DESCRIPTION OF DRAWING

The invention together with the above and other objects and advantages will be best understood from the following detailed description of the preferred embodiment of the invention shown in the accompanying drawings, wherein:

FIG. 1A is a photomicrograph showing surface detail of a prior art particle;

FIG. 1B is a photomicrograph of a cross section of the particle depicted in FIG. 1A.

FIG. 1C is a magnified image of the cross section depicted in FIG. 1B;

FIG. 2A is a photomicrograph of a cathode particle comprising lithium iron phosphate, in accordance with features of the present invention;

FIG. 2B is a photomicrograph of a cathode particle comprising lithium nickel-cobalt manganese oxide, in accordance with features of the present invention;

FIG. 2C is a photomicrograph of a another cathode particle comprising lithium nickel cobalt manganese oxide having a nickel content higher than that depicted in FIG. 2B, in accordance with features of the present invention;

FIG. 3A is a schematic drawing of the invented carbon-layered single-crystal particle, showing less lithium proximal to its surface, in accordance with features of the present invention;

FIG. 3B is a schematic drawing of the granulated carbon layered and linked secondary particle, in accordance with features of the present invention;

FIG. 3C is a schematic drawing of the granulated carbon-layered and linked CNT-linked secondary particle, in accordance with features of the present invention;

FIG. 3D is a schematic drawing of the carbon-layered CNT-embedded single-crystal particle, in accordance with features of the present invention;

FIG. 3E is a schematic drawing of the granulated carbon-layered and linked CNT-embedded secondary particle, in accordance with features of the present invention;

FIG. 3F is a schematic drawing of the granulated carbon-layered and linked CNT-embedded and linked secondary particle;

FIG. 4 is a schematic drawing of a device for enabling a continuous hydrothermal reaction, in accordance with features of the present invention;

FIG. 5A is a schematic drawing of a thermal jumper with three off axis injection points, in accordance with features of the present invention;

FIG. 5B is a schematic drawing of a thermal jumper with two off axis points and one coaxial injection point, in accordance with features of the present invention;

FIG. 5C is a schematic drawing of a thermal sinker with one central injection and one tangential injection point, in accordance with features of the present invention.

FIG. 6A is a schematic drawing of a de-pressurizer with a capillary tube and a single pressure regulator, in accordance with features of the present invention;

FIG. 6B is a schematic drawing of a de-pressurizer with capillary tube and two pressure reducing regulators, in accordance with features of the present invention;

FIG. 6C is a schematic drawing of a de-pressurizer having a plurality of capillary tubes with a plurality of pressure regulators, in accordance with features of the present invention;

FIG. 6D is a drawing of a coiled capillary tube, in accordance with features of the present in invention;

FIG. 7 is a flow chart of the continuous hydrothermal method, in accordance with features of the present invention;

FIG. 8 is a table of charging and discharging values exhibited by various cathode particle types, in accordance with features of the present invention;

FIG. 9A is a photomicrographs of the invented granulated carbon-layered particles, in accordance with features of the present invention;

FIG. 9B is a photomicrograph of an enlarged view of the particle depicted in FIG. 9A, in accordance with features of the present invention;

FIG. 9C is a photomicrograph of the invented granulated carbon-layered and linked CNT-linked secondary particle, in accordance with features of the present invention;

FIG. 9D is a magnification of the particle depicted in FIG. 9C, in accordance with features of the present invention;

FIG. 10A is a photomicrograph of carbon layered primary particles, in accordance with features of the present invention;

FIG. 10B is a photomicrograph a surface of one of the carbon layered particles called out in FIG. 10A, in accordance with features of the present invention;

FIG. 10C is a photomicrograph of numerous granulated secondary particles each composed of a plurality of carbon layered primary particles depicted in FIG. 10A, in accordance with features of the present invention.

FIG. 11 is an XRD result of the invented carbon-layered grain-free submicron primary single-crystal LFP particles with partially de-lithiated composition Li_{0.97}Fe(PO₄), in accordance with features of the present invention;

FIG. 12 is a carbon layer analysis of the invented carbon-layered grain-free submicron primary single-crystal LFP particles with partially de-lithiated composition Li_{0.97}Fe(PO₄), in accordance with features of the present invention; and

FIG. 13 is a graph of rate performance of the secondary (i.e., granulated) invented particle, in accordance with features of the present invention.

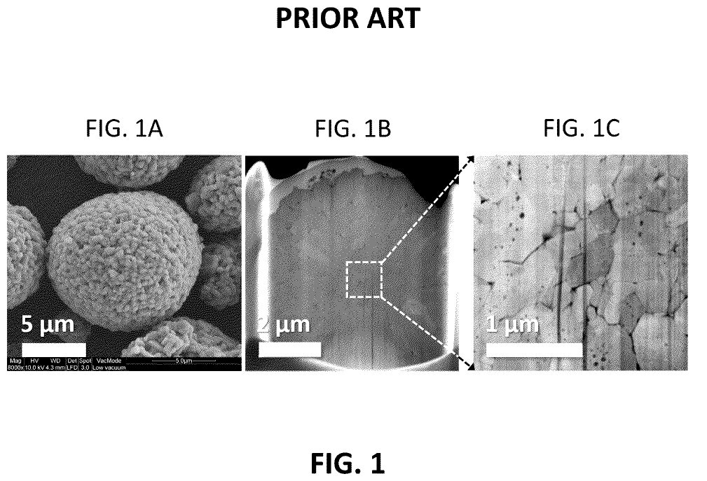

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As discussed supra, polycrystalline particles are unavoidably and naturally generated by conventional methods, necessarily involving internal grain boundaries. Cracking occurs during the charging and discharging process, resulting in internal disconnection. There are no electronic and ionic connections linking these internal pieces together. To solve the problem of polycrystalline cathode particles, robust single crystals (with no internal grain boundaries) are first made, and these are connected with carbon layers to create secondary particles that do not cause disconnection during charging and discharging. In this invention, the conventional (i.e., naturally occurring) polycrystalline material and the invented secondary material (relatively unnatural, but rather intentionally engineered) are differentiated.

The invention provides a method for generating a cathode particle that can prevent rapid impedance grown and capacity decay heretofore caused by inter-granular fracture found in state of the art paradigms.

The invention provides a robust cathode particle that is not of a polycrystalline particle structure. The particle, comprised of primary particles, is relatively small in size (e.g. 0.1 to 1 microns) to enable faster lithium access to the particle core and also features novel particle structure that promotes lithium and electron transfers between similar adjacent small particles. The particle has no internal grain boundaries and no residual lithium on its surface so as to mitigate the capacity drop and impedance growth inside and outside the particle during charge-discharge cycles. Also provided is a method for preparing this particle.

The invented submicron carbon-layered single-crystal cathode material for lithium-ion batteries shows improved capacity retention, good rate capability, and long cycle life. These benefits are obtained by mitigating impedance growth due to grain-free particle structure, less lithium concentration proximal to the surface than proximal to the core, and carbon-layered-linked-embedded particle structure.

In general, in order to increase the capacity of a battery, larger size cathode particles (for example between 10 microns and 30 microns in diameter), are preferable. But this results in the active area in contact with the electrolyte actually decreasing. (As the polycrystalline cathode particle has a larger micron size, the center of the particle is not used due to the limitation of lithium transfer under high C-rate charge-discharge cycling conditions.) Thus, the high C-rate capability and initial charge and discharge capacities of the particles deteriorate. That state of the art polycrystalline particles are composed of a cluster of primary particles, results in the existence of a grain boundary. Void fractions are therefore formed inside the polycrystalline particle, and this inter-granular fracture results in rapid impedance growth and capacity decay.

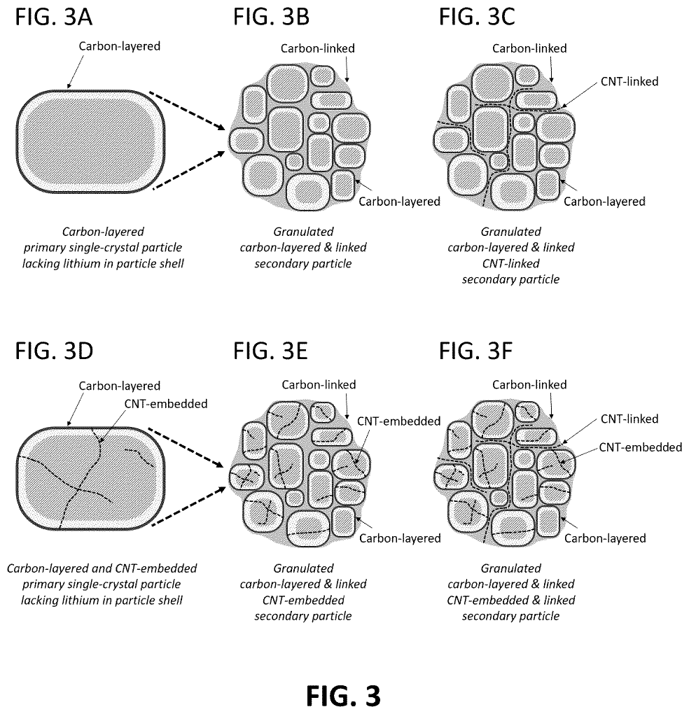

The present invention first manufactures small unbreakable (i.e., lacking internal grain boundaries) single crystals, and connects them to each other with layers of carbonaceous flexible mortar to produce secondary particles (granulated particles). (The diagram of the invented secondary particle is shown in FIG. 3, discussed infra.) The invented particle manufacturing process connects the invented single-crystal primary particles with CNT, graphene, carbonaceous mortar, and other types of flexible conductive mortar so as to form flexible electronic and ionic pathways between single-crystal primary particles. Flexible mortar endures the mechanical stress that primary or secondary particles receive according to the volume change during the charging and discharging process, and enables continuous particle-to-particle connection. A conductive self-healing polymer may be a good example of a flexible mortar. For example, grafting poly(ether-thioureas) (TUEG) on poly(acrylic acid) (PAA) through an amidation reaction, generates a self-healing polymer binder (PAA-TUEG). This provides beneficial for fast Li ionic conduction (and therefore more rapid charging) and self-healing ability. PAA-TUEG gel samples achieve greater than 80 percent healing efficiency at room temperature without any external intervention. In summary of this point, the incorporation of flexible conductive mortar assures that there is no particle breakage from stress generated during the charge/discharge cycles. Impedance growth and capacity decay are suppressed because the internal structure of this granulated secondary particle is continuously connected.

The inventors have found that when using smaller single-crystal particles, the cycle performance of olivine structure, spinel structure, and layered structure cathode materials, as well as high C-rate capability, is significantly improved due to the elimination of internal grain boundaries and inter-granular fracture. An embodiment of the invention is combining conductive material and submicron robust single-crystal particles having no internal grain boundaries and lacking lithium at the particle surface proximity. This results in significantly higher cycle performance of cathode materials due to the elimination or minimization of inter-granular fracture, lithium impurity formation, and impedance growth. This improved electrochemical performance is partially ascribed to the shorter Li-ion and electron transport pathways. The improved electrochemical performance is also due to the large surface-to-volume ratio which facilitates the diffusion of Li-ion into the particle's core and the structural and mechanical stability (e.g., stability) of grain-free single-crystal particles.

The invention further provides single crystal LFP cathode material (e.g., (Li_{0.97}FePO₄), without excess/residual lithium at the surface of the materials. The invented cathode material displays excellent rate performance.

The invention provides micron-scale (e.g., 1 to 30 microns in diameter) granulated carbon-linked secondary cathode particles comprising nano-scale (e.g., 0.1 to 1 micron in diameter) carbon layered single crystal primary cathode particles. As such, each granulated secondary cathode particle has internal carbon linkages, while their constituent single crystal primary cathode particles are carbon-layered.

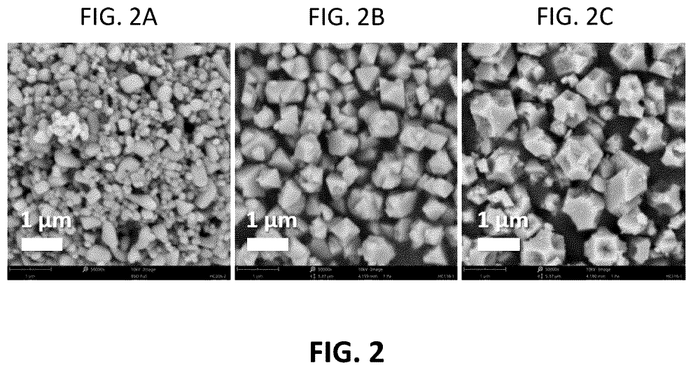

FIG. 2 is a series of photomicrographs of the invented nano-scale carbon-layered single crystal primary cathode particles. The first photomicrograph (FIG. 2A) is lithium iron phosphate. The middle photomicrograph (FIG. 2B) is lithium nickel cobalt manganese oxide with 80% nickel content. The third photomicrograph (FIG. 2C) is lithium nickel cobalt manganese oxide with 96% nickel content.

FIG. 3 depicts different embodiments of the invented carbon-layered single-crystal particle. It should be noted that while carbon is the primary layering and linking material, other electrically conductive substances are also suitable. The figure emphasizes that carbon-layering occurs when synthesizing primary particles, and carbon-linking occurs when creating granulated (i.e., secondary) particles.

FIG. 3A depicts a primary single crystal primary particle over-layered (e.g., encapsulated) with a carbon layer.

FIG. 3B depicts a secondary particle comprising several primary particles of the type shown in FIG. 3A. As such, this secondary particle is comprised of a plurality of primary particles (i.e. such that the secondary particles are sometimes referred to herein as being granulated). This structure features carbon-layered primary particles (defining a first carbon layer) in physical contact with each other to form inter-particle (i.e., between-particle) carbon linkages (defining a second carbon layer). In this granulated structure, the carbon layer of each of the primary particles combine, via carbon links, to form linked granulated structure (defining a third carbon layer). These layers, in combination provide an electrochemical pathway between secondary particles.

FIG. 3C depicts the secondary particle shown in FIG. 3B but with the addition of carbon nanotubes coursing between the primary particles. As such, the secondary particle of FIG. 3C features a carbon-layered and electronically-, ionically-linked (via carbonaceous mortar and CNT) granulated structure.

FIG. 3D depicts the primary particle structure of FIG. 3A but with the addition of carbon nanotubes embedded and otherwise extending through the primary particles. As such, the invented primary particles each have two localized conducting pathways. The first is the carbon-layered surface of the primary particle and the second is the embedded CNTs inside the primary particle.

FIG. 3E depicts secondary particles each comprising a plurality of primary particles depicted in FIG. 3D which are granulated (e.g. combined together) into a carbonaceous conducting matrix. The combination may result in a homogeneous matrix. The resulting granulation results in the formation of wide-area conducting pathways both inside (i.e., within the interior) and outside (i.e., on the exterior) each of the secondary particles. The carbon film overlaying each of the primary particles combine to form carbon linkages to an entire secondary particle, thereby forming a cathode-material-wide conducting pathway.

FIG. 3F depicts the secondary particles of FIG. 3E but with the addition of CNTs coursing between individual primary particles. Therefore, this embodiment includes a first carbon layer (the film overlaying the primary particle surface serving as a first localized conducting pathway), a second carbon layer (the CNTs confined or embedded within each of the primary particles as a second localized conducting pathway), a third carbon linkage (carbon film overlaying each of the primary particles to form a carbon linkage to an entire secondary particle as a third wide area conducting pathway), and a fourth carbon linkage (the CNTs coursing between the individual primary particles as a fourth wide area conducting pathway). The second carbon layer in essence ionically and electronically links together internal regions of the primary particle. (During charging and discharging, the movement of lithium ions and electrons occurs simultaneously.) This allows lithium ions to immediately access the particle core for high C-rate capacity. The third carbon linkage ionically and electronically links internal regions of the secondary particle to each other and to the exterior surfaces of the secondary particle.

This novel-designed secondary particle structure allows lithium ions to immediately access the particle core for high C-rate capability via 3-dimensional net-like electrochemical connections across both local primary particles and wide-area secondary particle so as to facilitate rapid charging. In summary of this point, in an embodiment of this invention, primary particles provide local carbon layers and secondary particles utilize those layers together with an additional carbon film provided by a granulation process to form wide-area carbon links. Carbon-layered single crystal particles (with localized carbon layers) with a size of 0.1 to 1 micron are first made by the invented hydrothermal process, and carbon-linked secondary particles (with 3-dimensional net-like wide-area carbon linkages) with a size of 1 to 30 microns are produced through granulation.

Yet another embodiment of the invented secondary structure features CNTs coursing between primary particles and which are in electronic and ionic communication with CNTs embedded within those primary particles. In this embodiment, the externally situated CNTs physically contact portions of internally situated CNTs which may be breaching the surface of the primary particles in which they reside.

A salient feature of the invention is that the primary particles of the cathode material are single-crystal. This means that each primary particle is a robust solid substance (i.e., lacking any internal voids or grain boundaries) having a natural geometrically regular form with symmetrically arranged plane faces. Its component atoms are arranged in a definite pattern and its surface regularly reflects its internal symmetry. While these single-crystal particles withstand the stress of volume change that occurs repeatedly during battery charging and discharging, particle breakage is suppressed. These primary particles have a shape selected from the group consisting of spherical, non-spherical, elliptical, oval, convex, concave, leaf, needle, plate, polyhedron, sloped polyhedron, slanted polyhedron, curved polyhedron, and combinations thereof. In an embodiment of the invention, all of the primary particles may be of similar same shape and size. In another embodiment, the primary particles may be different sizes and shapes.

State of the art polycrystalline particles on the other hand, are broken along the internal grain boundaries, thereby hindering the transfer of lithium ions and electrons due to disconnection from adjacent structures.

Using a submicron robust single-crystal particle structure bonded to a conductive material with no grain boundary inside the particle and no residual lithium on the particle surface proximity, the cycle performance of olivine-structure, spinel-structure, layered-structure, cation-disordered-rock salt-structured cathode materials is significantly improved by mitigating the inter-granular fracture, lithium impurity formation, and impedance growth. (Cation-disordered-rock salt-structure comprises a crystalline structure with a disordered arrangement of lithium and transitional metals on a cation lattice.)

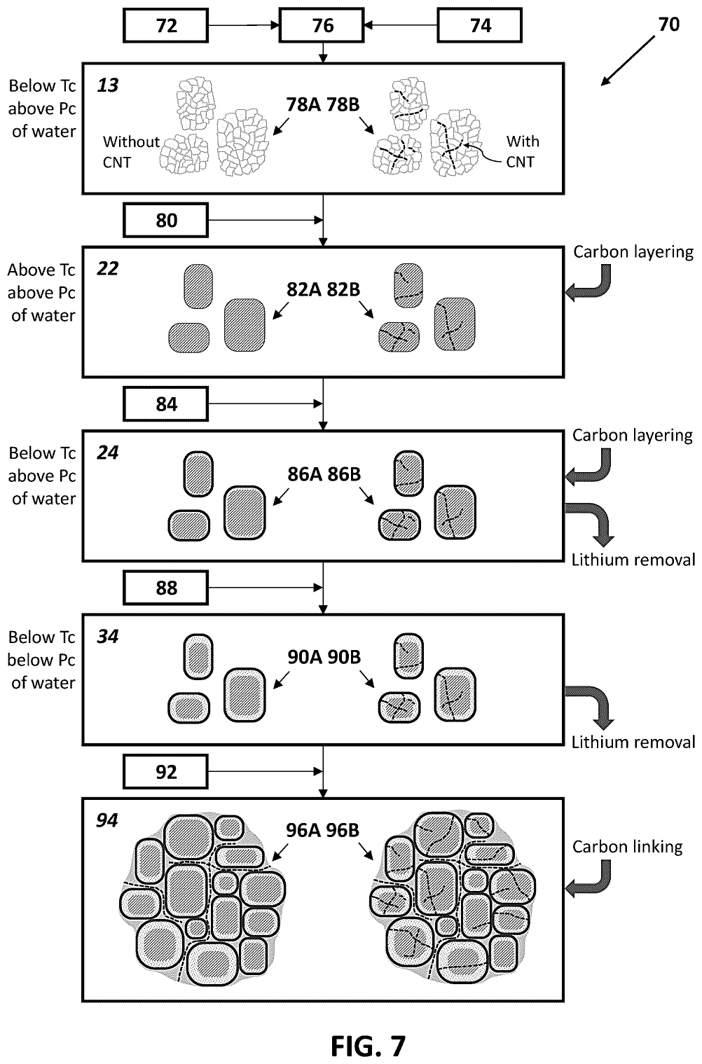

These single crystals are layered with carbon, so as to display a carbon embedded structure, CNT embedded structure, graphene embedded structure, and combinations thereof. The CNTs may be mixed with the precursor solution or else created shortened or modified simultaneously during the hydrothermal process, as depicted in the flow chart of FIG. 7

The single crystal particle may be comprised of different constituents. For example, a carbon-layered single-crystal cathode particle may comprise the formula Li₁₊ₓMPO₄ with −0.05<x≤0.05, and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

Alternatively, a carbon-layered single-crystal cathode particle may comprise the formula Li₁₊ₐNiₓCo_{y}Mn_{z}M_{w}O₂ with −0.05≤a≤0.05, x+y+z+w=1, 0≤x≤1, 0≤y≤1, 0≤z≤1, 0≤w≤1 and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

Alternatively, the carbon-layered single-crystal cathode particle may be comprised of the formula LiₐNiₓCo_{y}Mn_{z}M_{w}O_{2+δ} with 0.95≤a≤2, 0≤x≤1, 0≤y≤1, 0≤z≤1, 0≤w≤1, 0≤δ≤1, x+y+z+w=1, and M is selected from the group consisting of B, F, Na, Mg, Al, Si, Ca, Sc, S, Ti, V, Cr, Fe, Cu, Zn, Ga, Ge, Sr, Y, Zr, Nb, Mo, Ru, Ag, In, Sn, Sb, Ba, La, W, Ta, Bi, and combinations thereof.

Alternatively, the carbon-layered single-crystal cathode particle may comprise at least two particulate constituents selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

Alternatively, the carbon-layered single-crystal cathode particle may comprise at least two concentration changes from the core to the surface of constituents selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

In summary, the invented carbon-layered single-crystal cathode primary particles may have a size distribution between 0.01 microns and 3 microns (and preferably between 0.1 microns to 1 micron) and are combined to form a cathode electrode for lithium-ion batteries. When the primary particles are combined to form secondary particles, the carbon linkages of each of the secondary particles may become in electrical communication with each other and may also physically contact each other to form contiguous ionic and electronic pathways. These pathways may extend through the entire secondary particle so as to transport ionic species (e.g., Li-ions) from one secondary particle to adjacent secondary particles.

### Hydrothermal Reaction

### Details

The carbon-layered primary single-crystal structures provided by the invention are produced via a continuous hydrothermal reaction. (The invented process is considered continuous inasmuch as the agglomerated mixture of reactants, such as metal salts, carbon stock and lithium sources are continuously fed into a main reaction chamber to generate the primary single crystal grain free lithiated particles at supercritical water conditions. Those primary particles are then continuously fed to an auxiliary reaction chamber at subcritical water temperatures to be partially delithiated and therefore yield carbon-layered primary single-crystal particles lacking lithium in the particle's shell. (These single crystal particles are combined to generate secondary particles, i.e., the eventual cathode materials.) For example, depending on the battery application, the produced single crystal particles themselves are directly used as constituents of battery cathode materials after heat treatment, or constituents of heat-treated secondary particles comprising the produced single crystal particles.

The invented hydrothermal synthesis method enables a rapid (within 5-10 minutes production of single-crystal cathode particles without internal void fractions or grain boundaries as well and without excess/residual lithium on the particle surface. The method produces grain-free single-crystal olivine structured LiFePO₄ particles as well as grain-free single-crystal layer-structured NMC particles, which implements all synthesis steps as a continuous-flow process. As a result, the processing time is reduced dozens of time times (e.g., a 50-fold decrease in time) compared to the conventional polycrystalline cathode synthesis method which utilizes co-precipitation methods.

Using the invented method, carbon embedded-layered-linked grain-free single-crystal cathode materials are produced and this unlocks a new synthesis approach that can overcome the limitations of conventional polycrystalline cathode materials.

A continuous hydrothermal manufacturing device is used. This novel process provides high precision, rapid, and in-situ control of single-crystal particle morphology and size distribution through adjusting reaction pressure, reaction temperature, reaction time, reactant concentration, solvent type, additives, etc.

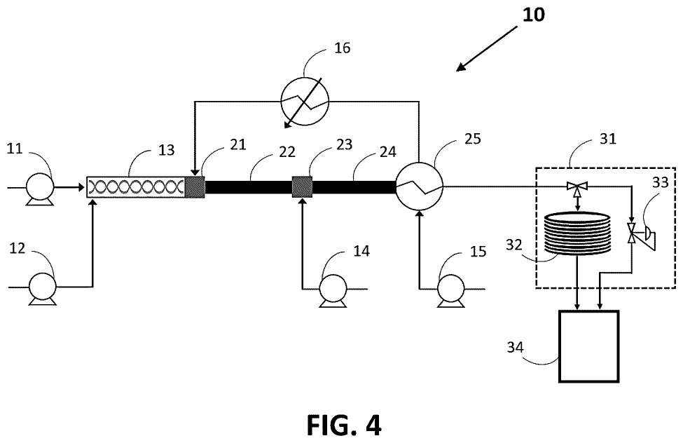

FIG. 4 is a schematic depiction of a device (designated as numeral 10) for enabling the continuous hydrothermal reaction. The upstream end of the device 10 comprises a first high pressure feed pump 11 to supply aqueous metal salt fluid, a second high pressure feed pump 12 to supply aqueous lithium fluid, and a generator of agglomerated solid particles 13 positioned downstream from the aforementioned pumps and physically connected to both. The solid particles generator 13 is generally tubular in construction with a first end communicating with the first and second high pressure feed pump fluids and a second end connected to a thermal jumper 21. Either gas-phase, liquid-phase, solid phase, or combination gas-liquid-solid phase feedstocks can be utilized.

The thermal jumper 21 is positioned downstream from the solid particles generator 13 so as to physically contact both the solid particles generator 13 and a main reactor 22. The main reactor 22 is depicted as a tubular reaction chamber with a longitudinal axis coaxial to the solid particles generator 13. While FIG. 4 shows this coaxial relationship, the solids particles generator 13 and main reactor 22 need not be coaxially arranged, just so long as they are in fluid communication with each other. For example, the solid particles generator 13 and main reactor 22 may be positioned at an angle relative to each other that is different than 180 degrees.

Downstream from the main reactor 22 is a thermal sinker 23 in direct fluid communication with a high pressure pump 14 of carbon-containing aqueous solution.

A high pressure pump of water 15 directly feeds a heat exchanger 25, and the ensuing heated water is fed to a supercritical water heater 16 downstream from the exchanger 25. This generates supercritical water to feed into the thermal jumper 21. An auxiliary reactor 24 is positioned upstream from, and directly connected to, the heat exchanger 25.

A de-pressurizer 31 is in fluid communication with and downstream from the exchanger 25. A phase separator 34 is positioned downstream from the de-pressurizer 31, and in thermal communication and direct contact therewith.

The aqueous metal salt solution comprises compounds selected from the group consisting of water, alcohol (e.g., ethanol, methanol, Isopropyl alcohol), metal salt (water-soluble metal compounds such as alkoxides, nitrates, acetates, halides, oxides, carbonates, oxalates, sulfates), phosphate compound (such as phosphoric acid, ammonium phosphate, hydrogen ammonium phosphate, lithium phosphate, and iron phosphate), metal particles (nano-size or micron-size metal solid particles), metal hydroxide particles (nano-size or micron-size metal hydroxide solid particles), metal carbonate particles (nano-size or micron-size metal carbonate solid particles), metal oxide particles (nano-size or micron-size metal oxide solid particles, organic additive (e.g., formic acid, decanoic acid, oleic acid), oxidizing agent, carbon source, and combinations thereof.

The oxidizing agent may be selected from a material selected from group consisting of oxygen, hydrogen peroxide, ozone, metal-containing oxidizing agent, and combinations thereof.

The carbon source may be a material selected from the group consisting of carbon, hydrocarbon, carbon nanotube (CNT), carbon nanofiber, graphene, microporous carbon, mesoporous carbon, nanoporous carbon, carbonaceous mortar, flexible conductive mortar, hydrazine, oxalic acid, vitamin C, sucrose, fructose, ascorbic acid, cellulose, polyvinyl alcohol, polyethylene glycol polymer, carbon-containing organic agent (e.g., formic acid, decanoic acid, oleic acid), and combinations thereof.

The aqueous lithium solution comprises lithium salts. Specifically, the aqueous lithium solution comprises compounds selected from the group consisting of water, alcohol, lithium hydroxide, lithium nitrate, lithium carbonate, lithium sulfate, lithium acetate, lithium-containing component (e.g., Li₂PO₄), alkalinizing component (e.g., NaOH, KOH, Ca(OH)₂, Mg(OH)₂) chelating agent (e.g., NH₄OH, NH₄NO₃), organic additive, oxidizing agent, carbon source, and combinations thereof.

The agglomerated solid particles, formed by mixing the aqueous metal salt solution and the aqueous lithium solution together, are exposed to a myriad of mixing techniques, including but not limited to laminar flow mixing, turbulent flow mixing, static in-line mixing, agitator mixing, sonication mixing, and combinations thereof. This mixing occurs below the critical temperature and above the critical pressure of water.

The supercritical water comprises compounds selected from the group consisting of water, oxidizing agent, reducing agent (e.g., hydrogen), carbon source, organic additives, and combinations thereof.

The carbon-containing aqueous solution comprises compounds selected from the group consisting of water, alcohol, metal salt, organic additive, carbon source, and combinations thereof. These compounds provide a reducing reaction condition inside the auxiliary reactor 24 and the heat exchanger 25 (by removing oxygen from the effluent from the main reactor 22, inasmuch as oxygen reacts with the carbon source to generate carbon dioxide). After the continuous hydrothermal process, the prepared carbon-layered single-crystal cathode particles are filtered, washed, dried, and heat treated. As another embodiment of the present invention, the prepared carbon-layered single-crystal cathode particles are filtered and washed, then linked together using the carbon source to form a granulated secondary particle by granulator.

The granulation process utilizes devices selected from the group consisting of a fluid-bed dryer, a spheronizer, a spray dryer, a centrifugal rotator, a pelletizer, a crusher, a particle size classifier, and combinations thereof. The granulation may be used in the drying step, may be used before or after the heat-treating, and may be used simultaneously before and after the heat-treating.

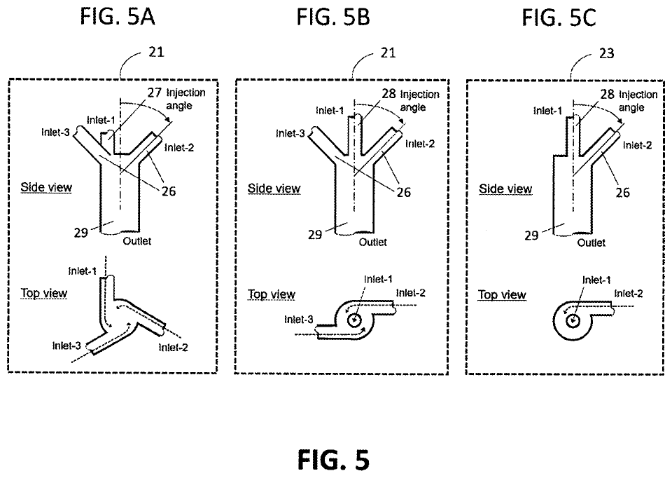

FIGS. 5A-C are schematic drawings of the thermal jumpers 21 and the thermal sinker 23 initially depicted in FIG. 4. One embodiment of the thermal jumper 21 depicted in FIG. 5A features two tangential injection ports 26 and a single off axis injection port 27 that is nevertheless parallel to the longitudinal axis (dashed line) of the thermal jumper 21. A means of fluid egress is depicted downstream of the inlet ports as an outlet 29.

Another embodiment of the thermal jumper 21 is shown in FIG. 5B and features tangential fluid ingress means (i.e., injection ports) 26 similar to that shown in FIG. 5A. However, a single on-axis ingress means 28 is also shown.

FIG. 5C provides detail of the downstream thermal sinker 23 depicted in FIG. 4. This thermal sinker 23 comprises an on axis ingress means 28 and a single tangential means of ingress 26.

The injection angles of the tangential means of ingress relative to the longitudinal axis of the jump can vary from 10 to 90 degrees, preferably 20 to 80 degrees, and most preferably 40-60 degrees. With devices having more than one tangential means of ingress or injection point, the angles relative to the longitudinal axis of a first means of tangential ingress may be similar or different to or from the angle of a second means of tangential ingress. For example, the injection angle of inlet 3 in FIG. 5A may be 20 degrees, while the angle of inlet 2 in FIG. 5A may be 30 degrees. As further depicted in the top views of FIGS. 5A-5C, the tangential ingress means impart a vortex flow to the fluid being treated. The off axis and on axis injection ports confer central or direct injection force to fluid coursing through the thermal jumper 21 and thermal sinker 23.

Downstream from these injection ports is a concentrically arranged means of egress or outlet 29. It should be noted that the mixing pattern changes according to the flow direction of the feed streams injected into the thermal jumper 21. Particle morphology is obtained accordingly.

The thermal jumper 21 provides non-gradual (e.g. sudden) increases of heat to the agglomerated solid particles from a subcritical temperature to a supercritical temperature of water. This occurs by direct mixing the particles with supercritical water supplied from the supercritical water heater 16. Metal and carbon components that are combined into agglomerated solid particles are injected into the thermal jumper and form carbon-layered single-crystal metal particles under a rapid supersaturation condition as the temperature increases non-gradually to above the critical temperature of water.

The thermal sinker 23 conducts a non-gradual temperature decrease of the carbon-layered single-crystal metal particles from a supercritical temperature to a subcritical temperature of water by the carbon-containing aqueous solution. (Examples of a non-gradual temperature decrease include a sine wave form, a tangential form, a stair step form, saw tooth wave form, and combinations thereof.) The temperature decrease may be stepwise, or all in one step (e.g., within seconds. Within the thermal sinker 23, there is direct mixing of the carbon-layered single-crystal metal particles and the carbon-containing aqueous solution. Thereafter, inside the auxiliary reactor 24 (situated downstream from the thermal sinker), reduction reaction conditions are established and oxygen is converted into carbon dioxide or water, or both.

The auxiliary reactor 24 is maintained below the critical temperature and above critical pressure of water. The auxiliary reactor 24 is tubular or vessel shape with or without a mixing part such as an impeller, a static in-line mixer, or a sonicator. It has a first upstream end in physical contact and thermal communication with the thermal sinker 23. A second and downstream end of the auxiliary reactor 24 is in physical contact and thermal communication with a heat exchanger 25. The heat exchanger 25 cools the effluent from the auxiliary reactor 24 and heats the water going into the supercritical water heater 16 above the critical pressure of water. The supercritical water heater 16 supplies supercritical water solution to the thermal jumper 21.

The continuous hydrothermal reaction process features a pressure letdown apparatus to discharge a product continuously while keeping reaction pressure above the critical pressure of water at the same time. As such, a de-pressurizer 31 depressurizes and discharges the effluent from the hydrothermal reaction.

Conventional pressure-reducing regulators are easily plugged by particle sedimentation and malfunctions when the product contains solid highly abrasive material. This triggers or otherwise initiates a process safety hazard and prevents or otherwise disturbs the continuous operation of the process. The erosion of the valve seat of pressure-reducing regulators by the collision of solid particles triggers the contamination of the product. In addition, when the synthesized particles discharge through the narrow gap between the seat and positioner of the pressure-reducing regulator, the solid particles experience breakage by both the mechanical stress and severe pressure changes during the continuous open and close operation of the pressure-reducing regulator.

By contrast, the invented continuous hydrothermal reaction process utilizes the capillary tube as the component of the de-pressurizer 31. Therefore, malfunction, plugging, erosion, and particle cracking are minimized during pressure letdown. This is because the capillary tube configuration of the invented device is devoid of any moving parts or diaphragms which otherwise would contact the particles.

An embodiment of the de-pressurizer 31 is a combination of capillary tubes with an inner diameter between 1 and 15 mm and pressure-reducing regulators. This design minimizes severe pressure changes and provides gradual pressure reduction along their lengths. The phase separator 34 separates the carbon-layered single-crystal cathode particles, water, and gas into each phase.

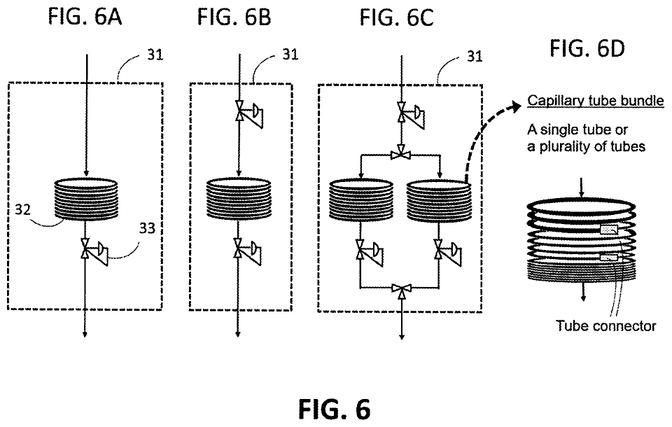

FIGS. 6A-C are schematic drawings of the de-pressurizer 31 with capillary tubes and pressure reducing regulators and three coiled capillary tubes connected in series with each tube depicting different tube diameters.

FIG. 6A is a schematic drawing of a de-pressurizer with a capillary tube and a single pressure regulator.

FIG. 6B is a schematic drawing of a de-pressurizer with capillary tube and two pressure reducing regulators.

FIG. 6C is a schematic drawing of a de-pressurizer having a plurality of capillary tubes with a plurality of pressure regulators.

FIG. 6D is detail of a capillary tube bundle 32 utilized in the de-pressurizers 31.

The invention provides a method for preparing carbon-layered single-crystal cathode particles with less lithium concentration proximal to the surface than proximal to the core. The particles feature grain-free and carbon-embedded structure. The lithium concentration inside the formed submicron single-crystal lithiated particle of the main reactor 22 shows a superior uniform lithium concentration distribution due to the homogeneous atomic level mixing properties of the hydrothermal reaction. This contrasts with polycrystalline cathode particles which cannot have internal uniform lithium concentrations because of the slow solid-phase reaction (non-uniform lithium distribution) between their component precursor particle and lithium source particles during the calcination process, which requires at least several hours (and typically 10-30 hours) of heat treatment above 700° C.

The lithium distribution of submicron single-crystal lithiated particles produced in the main reactor 22 is uniform. From the auxiliary reactor 24, lithium in the particle shell is partially removed by dissolving in water. Therefore, the lithium distribution in the particle core bulk is uniform. Concomitantly, the lithium distribution and concentration in the particle shell bulk is not uniform inasmuch as the lithium concentration exhibits a decrease closer to the particle surface. The average lithium concentration of single crystal particle shell bulk is between 50 and 95 percent of the lithium concentration of particle core bulk.

This uniform lithium concentration inside the submicron single-crystal lithiated particle is achieved because, in the main reactor, near instantaneous supersaturations (determined by non-gradual thermal jump) occur under supercritical water conditions of all metal components which are already homogeneously mixed below the critical temperature and above the critical pressure of water. For example, supersaturations may occur within 0.1 to 10 nanoseconds. The formation of the submicron single-crystal lithiated particles by instantaneous supersaturation is completed in seconds (e.g., within 0.1 to 10 seconds). Since the formation of the submicron single-crystal lithiated particles by instantaneous supersaturation is completed in seconds, the reaction time of the main reactor is set from seconds to minutes.

FIG. 7 is a flowchart of the invented method for continuous hydrothermal formation of the invented particles. The method comprises supplying the aqueous metal salt solution 72 below 100° C. and above the critical pressure of water; supplying the aqueous lithium solution 74 below 100° C. and above the critical pressure of water; wherein the aqueous metal solution and the aqueous lithium solution are initially supplied separately so as to be chemically isolated from each other.

The two solutions are mixed together 76 below the critical temperature (T_{c}) and above the critical pressure (P_{c}) of water to generate agglomerated solid particles 78 in the solid particle generator 13. 78a depicts an agglomerated solid particle having an amorphous shape lacking a clear crystal structure and 78b depicts amorphous agglomerated solid particles holding embedded CNTs (when the aqueous metal salt solution 72 contains CNTs). The amorphous agglomerated solid particles are then injected into the main reactor 22 together with a supercritical water 80 so as to make a non-gradual thermal jump of the agglomerated solid particles from a subcritical temperature to a supercritical temperature of water. The uniform lithium concentration inside the submicron single-crystal lithiated particle (82a and 82b) is achieved because, in the main reactor 22, instantaneous (non-gradual) supersaturations are applied under the supercritical water condition of all metal components which are already homogeneously mixed with lithium source in the solid particle generator 13 below the critical temperature and above the critical pressure of water. Since the mixing of lithium and metal components takes place in the liquid phase, uniform distribution of the components at the atomic level is achieved. The formation of the submicron single-crystal lithiated particles 82a and 82b by instantaneous supersaturation is completed in seconds. Since the formation of the submicron single-crystal lithiated particles 82a and 82b by instantaneous supersaturation is completed in seconds, the reaction time of the main reactor 22 is set from seconds to minutes.

The composition of the aqueous metal salt solution will determine the features of the conductive layers. For example, when the aqueous metal salt solution comprises carbon, CNTs, and graphene, then the formation of single-crystal lithiated particles 82, comprising grain-free structure, carbon-layered structure, carbon-embedded stricture, CNT-embedded structure, graphene-embedded structure, and combinations thereof occurs.

On the surface of the formed single-crystal lithiated particles 82a and 82b, additional carbon-layers are formed when a carbon-containing aqueous solution 84 below 100° C. and above the critical pressure of water is injected into the auxiliary reactor 24 through the thermal sinker 23. Under these conditions, the carbon-containing aqueous solution 84 makes a non-gradual thermal sink of the single-crystal lithiated particles 82a and 82b from a supercritical temperature to a subcritical temperature of water. Lithium is removed 86a and 86b from the surface of the single-crystal lithiated particles 82a and 82b by contacting same with water below the critical temperature and above the critical pressure of water. Simultaneously, the carbon-layers 86a and 86b are formed on the surface of the single-crystal lithiated particles 82a and 82b. Also simultaneously, deposition of metal components may be formed on the surface of the single-crystal lithiated particles 82a and 82b by mixing a carbon-containing aqueous solution in the case that the solution contains metal salts, which results in the concentration changes of metal constituents from the particle core to the particle surface.

Additional lithium is removed 90a and 90b from the single-crystal lithiated particles by contacting the particles with cooled and depressurized water effluent solution 88 that is supplied below the critical temperature and below the critical pressure of water in the phase separator 34. Finally, the single-crystal lithiated particles lacking lithium on and proximal to their exterior surfaces 90a and 90b are dried, and granulated 96a and 96b using a carbon source 92 in the granulation process 94. Then the produced granulated carbon layered-linked secondary particles 96a and granulated carbon-layered-linked CNT-embedded secondary particles 96b are heat-treated.

The heat treatment process comprises annealing by which the carbon-layered grain-free single-crystal partially de-lithiated particles, produced by the invented hydrothermal method, are thermally treated to release particle stresses and to increase particle crystallinity. The inventor has found that the phase change before and after annealing is minor or insignificant.

In summary, the continuous hydrothermal method, designated as numeral 70, comprises the following steps:
a) supplying 72 an aqueous metal salt solution below 100° C. and above the critical pressure of water;
b) supplying 74 an aqueous lithium solution below 100° C. and above the critical pressure of water; wherein the aqueous metal solution and the aqueous lithium solution are initially supplied separately so as to be chemically isolated from each other;
c) mixing 76 the aqueous metal salt solution and the aqueous lithium solution together below the critical temperature and above the critical pressure of water to generate agglomerated solid particles 78;
d) Injecting 78 the agglomerated solid particles into a main reactor 22 together with a supercritical water mixture 80 so as to make a non-gradual thermal jump of the agglomerated solid particles from a subcritical temperature to a supercritical temperature of water;
e) forming single-crystal lithiated particles 82, comprising grain-free structure, carbon-layered structure, carbon-embedded stricture, CNT-embedded structure, graphene-embedded structure, and combinations thereof, in the main reactor 22 above the critical temperature and the critical pressure of water. (Preferably, primary particles of the same size are generated to optimize control of process conditions.)
f) forming a carbon-layer 86 on the surface of the single-crystal lithiated particles 82 by mixing the carbon-containing aqueous solution 84 below 100° C. and above the critical pressure of water; wherein the carbon-containing aqueous solution makes a non-gradual thermal sink of the single-crystal lithiated particles from a supercritical temperature to a subcritical temperature of water;
g) simultaneously removing lithium 86 from the surface of the carbon-layered single-crystal lithiated particles 82 by contacting the crystals to the carbon-containing aqueous solution 84 below 100° C. and above the critical pressure of water;
h) simultaneously depositing metal constituents on the surface of the single-crystal lithiated particles 82 by mixing the carbon-containing aqueous solution 84 containing metal salts, so as to form concentration changes of metal constituents from the particle core to the particle surface.
i) removing additional lithium from the surface of the carbon-layered single-crystal partially de-lithiated particles 86 by contacting the crystals to the cooled and depressurized water effluent solution 88 (after the depressurizer 31) below the critical temperature and below the critical pressure of water in the phase separator 34. (The lithium concentration in the primary particle surface bulk is lowered. Also, there are gradual concentration changes in metal composition within the primary particle. This is due to a change in the metal composition of the primary particle surface bulk caused by the metal deposition of the injected metal salt contained in the carbon-containing aqueous solution 84 and the subsequent metal composition dissolution caused by contact with the cooled or depressurized water effluent solution 88.)
j) granulating and drying 96 the carbon-layered single-crystal lithiated particles lacking lithium on the particle surface using carbon source 92 in the granulation process 94 after filtering and washing, thereby creating a granulated carbon-layered-linked CNT-embedded secondary particle 96.

The aqueous metal salt solution comprises compounds selected from the group consisting of water, alcohol (such as methanol, ethanol, propanol, isopropanol), metal salt, phosphate compound (such as phosphoric acid, ammonium phosphate, hydrogen ammonium phosphate, lithium phosphate and iron phosphate), metal particles, metal hydroxide particles, metal carbonate particles, metal oxide particles, organic additive, oxidizing agent, carbon source, and combinations thereof.

The aqueous lithium solution comprises compounds selected from the group consisting of lithium hydroxide, lithium nitrate, lithium carbonate, lithium sulfate, lithium acetate, lithium-containing component, alkalinizing component, chelating agent, organic additive, oxidizing agent, carbon source, and combinations thereof.

The supercritical water comprises compounds selected from the group consisting of neat water, oxidizing agent, reducing agent, carbon source, and combinations thereof.

The carbon-containing aqueous solution comprises compounds selected from the group consisting of water, alcohol, metal salt, organic additive, carbon source, additives and combinations thereof;

The drying step includes the drying of granulated secondary particles composed of the carbon-layered single-crystal cathode particles together with carbon source.

The carbon-layered single-crystal lithiated particles lacking lithium on the particle surface forms granulated secondary particles by a granulator comprises fluid-bed dryer, spray dryer, spheronizer, centrifugal rotator, pelletizer (a device of agglomeration, or particle size enlarger, in which material fines are processed into pellets or granules) crusher, particle size classifier, and combinations thereof.

Also provided is a carbon-layered single-crystal cathode particle with less lithium concentration proximal to the surface than proximal to the core, wherein the particle lacks residual lithium compound on the surface, comprising grain-free structure, carbon-embedded structure, CNT-embedded structure, graphene-embedded structure, and combinations thereof.

The carbon-layered single-crystal cathode particles are combined to form a granulated secondary particle comprises carbon-linked structure, CNT-linked structure, graphene-linked structure, polymer-linked structure, solid electrolyte-linked structure, and combinations thereof.

The carbon-layered single-crystal cathode particle without surface residual lithium may comprise the formula Li₁₋ₓMPO₄ with 0<x≤0.05, and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

The carbon-layered single-crystal cathode particle without surface residual lithium may comprise the formula Li₁₋ₐNiₓCo_{y}Mn_{z}M_{w}O₂ with 0≤a≤0.05, x+y+z+w=1, 0≤x≤1, 0≤y≤1, 0≤z≤1, 0≤w≤1 and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

The carbon-layered single-crystal cathode particle without surface residual lithium may comprise the formula LiₐNiₓCo_{y}Mn_{z}M_{w}O_{2+δ} with 0.95≤a≤2, 0≤x≤1, 0≤y≤1, 0≤z≤1, 0≤w≤1, 0≤δ≤1, x+y+z+w=1, and M is selected from the group consisting of B, F, Na, Mg, Al, Si, Ca, Sc, S, Ti, V, Cr, Fe, Cu, Zn, Ga, Ge, Sr, Y, Zr, Nb, Mo, Ru, Ag, In, Sn, Sb, Ba, La, W, Ta, Bi, and combinations thereof.

The carbon-layered single-crystal cathode particle without surface residential lithium may comprise at least two particulate constituents selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

The carbon-layered single-crystal cathode particle without surface residual lithium may comprise at least two concentration changes from the core to the surface of constituents selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

The carbon-layered single-crystal cathode particle without surface residual lithium may have a size between 0.01 microns and 3 microns and preferably between 0.1 and 1 micron.

The carbon-layered single-crystal cathode particles may be combined to form a cathode electrode for lithium-ion batteries.

### EXAMPLE

Stoichiometric quantities of metal salts of cathode composition and sucrose were dissolved in distilled water. LiOH and NH₄OH solution was prepared. The two solutions were mixed at subcritical temperature of water and 230 bar. After the hydrothermal reaction at 380° C. and 230 bar, carbon-layered grain-free single-crystal cathode particles were obtained and the surface lithium was removed by subsequent water contact during cooling and separation. The produced material was filtered and washed, then dried in a vacuum oven at 100° C. overnight.

Afterward, annealing was carried out at 700° C. for approximately 1 hour. The carbon-layered grain-free single-crystal cathode particles of Li_{0.97}FePO₄ were thus obtained with less lithium concentration proximal to the surface than proximal to the core.

As another synthesis route, the produced carbon-layered grain-free single-crystal material was converted to granulated secondary particles with sucrose (and CNT) using a spray dryer after washing and filtering. Afterward, heat treatment was carried out at 700° C. for 1 hour so as to make granulated carbon-layered-linked (and CNT-embedded) secondary cathode particles wherein the particles lack residual lithium compound on the surface.

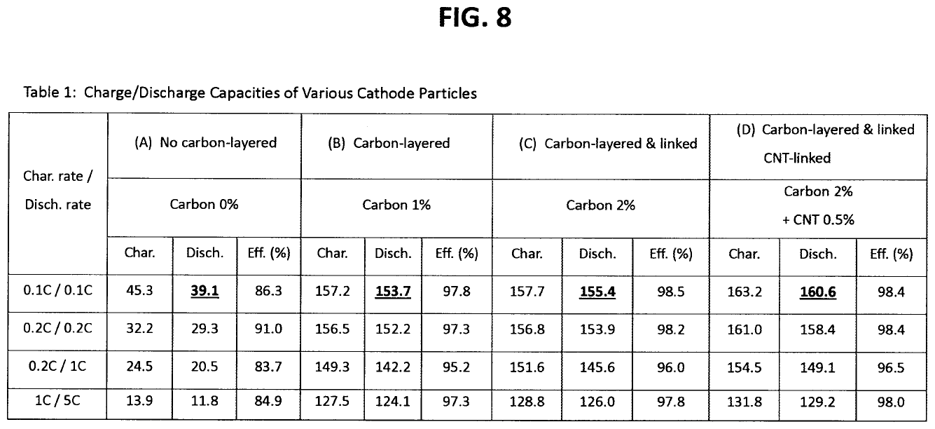

FIG. 8 is a table (Table 1) of charging, discharging, and first cycle efficiency values exhibited by the prepared various LFP cathode particle types.

To demonstrate the effectiveness of the invention, the charge and discharge performances of submicron single-crystal cathode particles without carbon layers (Column A), submicron carbon-layered single-crystal cathode particles (Column B), granulated carbon-linked secondary cathode material composed of submicron carbon-layered single-crystal cathode particles (Column C), granulated carbon-linked CNT-linked secondary cathode material composed of submicron carbon-layered single-crystal cathode particles (Column D) were prepared and compared. (Generally, in this invention, primary particles are carbon layered and secondary particles are carbon linked.) All the prepared submicron single-crystal cathode particles exhibit robust grain-free particle structures with less lithium concentration proximal to the surface than proximal to the core.

The discharge capacity of particles having no carbon layers at 0.1 C/0.1 C is 39.1 mAh/g, whereas when carbon-layering is applied, it rises to 153.7 mAh/g. The discharge capacity of the granulated carbon-layered and linked secondary cathode material composed of submicron carbon-layered single-crystal cathode particles with the capacity of 153.7 mAh/g is increased to 155.4 mAh/g.

The discharge capacity of the granulated carbon-layered and linked CNT-linked secondary cathode material composed of submicron carbon-linked single-crystal cathode particles with the capacity of 153.7 mAh/g is increased to 160.6 mAh/g. (Primary particles are carbon-layered and secondary particles are carbon-linked, CNT-linked.)

The electrochemical performance results compared and analyzed in Table 1 shows the improved effect of the invention not only on discharge capacity but also on rate performance and first-cycle efficiency of lithium-ion batteries. This confirms the effectiveness of the invention of carbon-layered structure, carbon-layered and linked structure, and carbon-layered and linked CNT-linked structure cathode materials using submicron single-crystal cathode particles. The secondary cathode material in column d of Table 1 is a structure in which carbon three-dimensionally links the submicron carbon-layered single-crystal cathode particles, wherein the CNTs are linked inside the granulated secondary cathode material. These results demonstrate that the electrochemical performance of submicron carbon-layered single-crystal cathode particles, whose interior is composed of a combination of grain-free structure, carbon-embedded structure, CNT-embedded structure, and graphene-embedded structure, is improved.

In summary, Table 1 shows electrochemical charge and discharge capacities of submicron no-carbon-layered single-crystal cathode particles (a), submicron carbon-layered single-crystal cathode particles (b), granulated carbon-linked secondary cathode material composed of submicron carbon-layered single-crystal cathode particles (c), and granulated carbon-linked CNT-linked secondary cathode material composed of submicron carbon-layered single-crystal cathode particles (d) of lithium iron phosphate cathode composition.

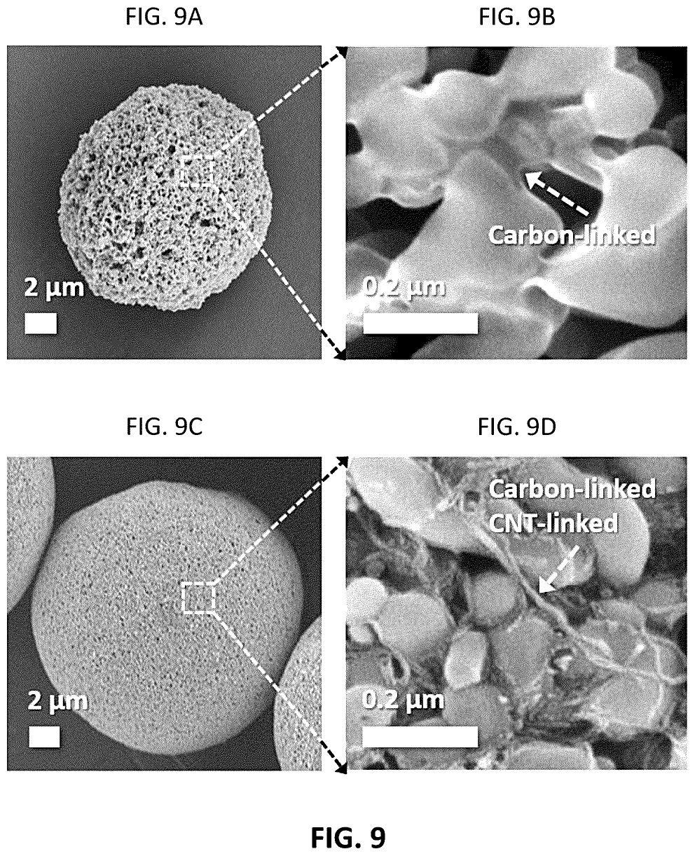

FIG. 9 is a series of photomicrographs of the invented secondary particle. Specifically, FIG. 9A is a photomicrograph of a granulated carbon-layered and linked secondary particle. FIG. 9B is a magnification of the particle depicted in FIG. 9A. FIG. 9C is a photomicrograph of the invented granulated carbon-layered and linked CNT-linked secondary particle. FIG. 9D is a magnification of the particle depicted in FIG. 9C.

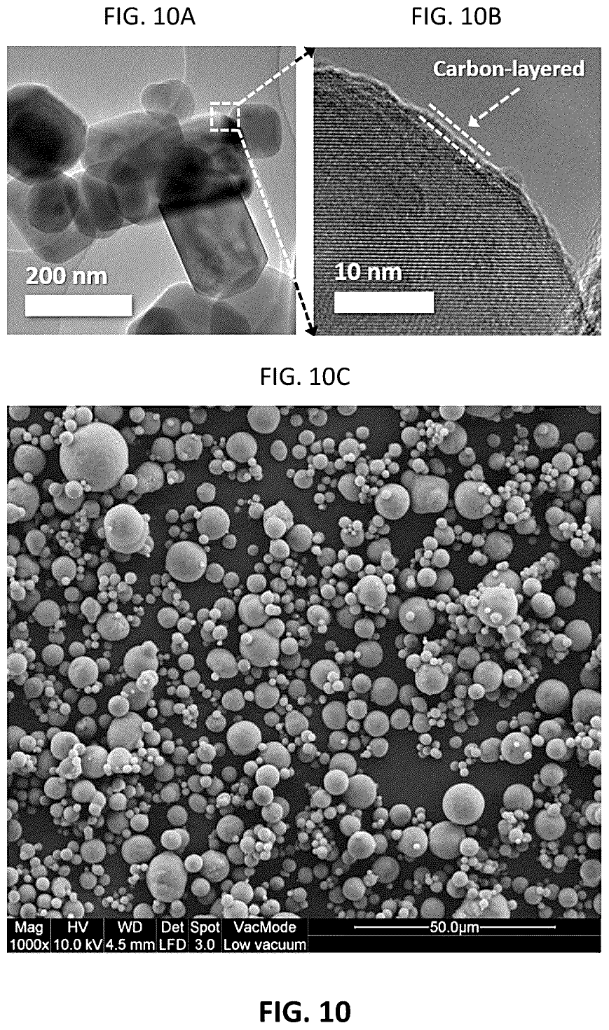

FIGS. 10A-C are photomicrographs of the invented carbon-layered grain-free submicron primary single-crystal LFP particles with partially de-lithiated composition Li_{0.97}Fe(PO₄) (FIG. 10A), magnified image of the particle surface showing carbon-layer (FIG. 10B), and a plurality of granulated carbon-layered and linked secondary particles (FIG. 10C). Each of the particles depicted in FIG. 10C are granulated secondary particles produced using single crystal particles (depicted in FIG. 10A) by a spray dryer or some other a granulation device.

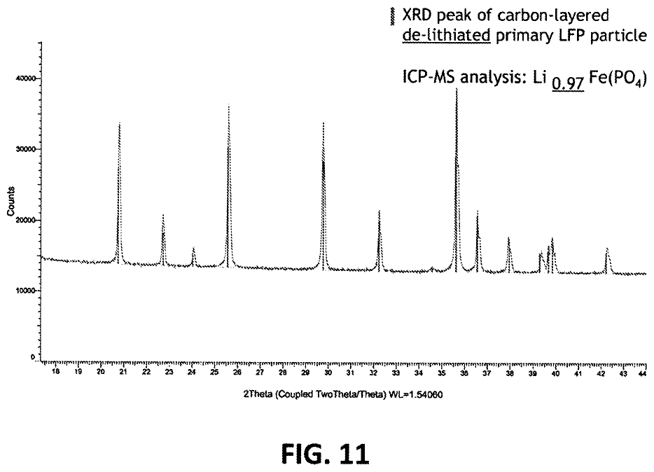

FIG. 11 is an XRD result of the invented carbon-layered grain-free submicron primary single-crystal LFP particles with partially de-lithiated composition Li_{0.97}Fe(PO₄). The intensity of the peak on the Y-axis indicates excellent particle crystallinity, and the peak position on the x-axis matches the XRD characteristics of the LFP composition.

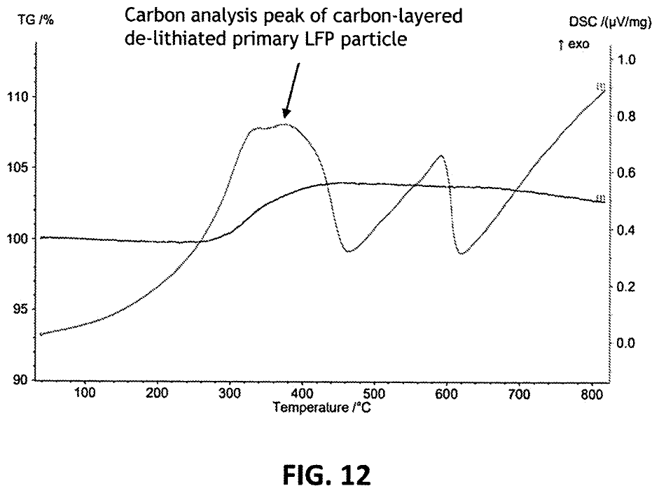

FIG. 12 is a carbon layer analysis of the invented carbon-layered grain-free submicron primary single-crystal LFP particles with partially de-lithiated composition Li_{0.97}Fe(PO₄). The exothermic peak of Differential Scanning calorimetry (DSC) analysis occurring in the temperature range of 300° C. to 400° C. on the x-axis means the presence of carbon, which indicates that there is a carbon layer on the surface of the primary LFP particle.

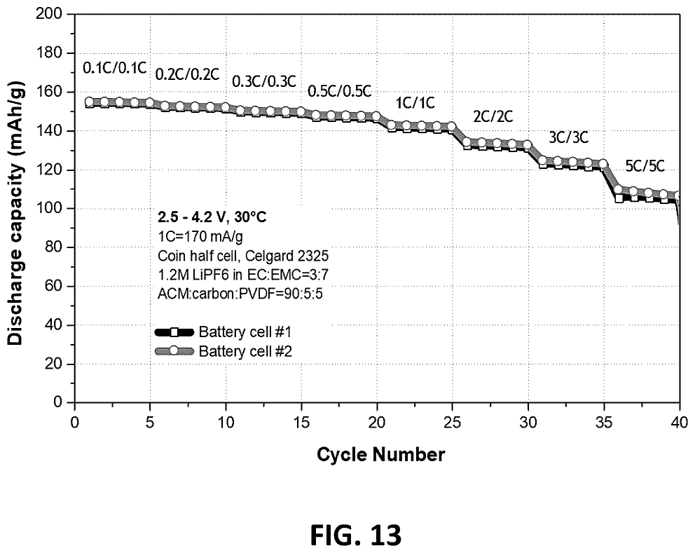

FIG. 13 is a graph depicting electrochemical rate performance of the invented granulated carbon-layered and linked secondary LFP particles. Specifically, the particle is secondary particle (i.e., granulated) and is carbon-layered and linked. It is comprised of the carbon-layered grain-free submicron primary single-crystal LFP particles having a partially de-lithiated composition Li_{0.97}Fe(PO₄). The Y-axis represents the discharge capacity at each C-rate (i.e., 0.1 C/0.1 C equates to 10-hour charge and 10-hour discharge, 1 C/1 C equates to 1-hour charge and 1-hour discharge, and 5 C/5 C equates to 12-minute charge and 12-minute discharge). Under the high C-rate condition of 5 C/5 C (12-minute charge and 12-minute discharge), which is 50 times faster than 0.1 C/0.1 C, the invented granulated carbon-layered and linked secondary LFP particles still maintain about 70% of the maximum discharge capacity.

In summary, the inventors have found that by using a submicron, robust single-crystal primary particle structure with no grain boundary inside that particle and lacking residual lithium on that particle's surface, the cycle performance of not only olivine-structure, but also spinel-structure, layered-structure, and cation-disordered-rock salt-structured cathode materials can be significantly improved, This improvement is the result of the elimination of inter-granular fracture, lithium impurity formation, and impedance growth.

The invention provides a secondary cathode particle with three-dimensionally-embedded internal carbon layers, wherein the particle contains less average lithium concentration at the particle shell than the average lithium concentration at the particle core. The secondary particle comprises primary single-crystal particles each having three-dimensionally-embedded internal carbon layers and less average lithium concentration at the primary single-crystal particle shell than the average lithium concentration at the primary single-crystal particle core. The carbon layers are comprised of individual carbon structures selected from the group consisting of carbon nanotubes, carbon nanofiber, graphene, graphite, microporous carbon, mesoporous carbon, nonporous carbon, carbonaceous mortar, flexible conductive mortar, and combinations thereof. The layers are contiguous with the surfaces of the primary single-crystal particles so as to be conduits for electronic communication.

To make less lithium concentration in the particle's surface bulk, during the invented hydrothermal synthesis process, the dissolution of lithium near the surface of the single crystal primary particle occurs due to the accompanying contact with water. The result is deficient lithium at its surface and shell located between the surface carbon layer and the single crystal primary particle core. Subcritical water contact with the lithiated particle removes lithium and lithium impurities proximal to the particle surface. Also, it modifies the near-surface bulk properties of the lithiated particle by Li⁺/H⁺ ion exchange between the lithiated particle and the subcritical water. This results in the particle having less lithium concentration at the near-surface bulk than at the core bulk, leading to very different near-surface structures (e.g., lithium-deficient, oxygen-deficient, rock salt, cation-mixing, cation-disordered structures, and combinations thereof) in the subsequent heat treatment. Significant Li⁺/H⁺ ion exchange of the lithiated single crystal particle by subcritical water contact produces a near-surface bulk layer with varying Li/transition metal molar ratios according to its morphology. The average lithium to transition metal molar ratio of particle surface bulk is between 0.5 and 0.95. The lithium to transition metal molar ratio of conventional LFP and NMC cathode particles is about 1.01˜1.05 (theoretically 1.0) and their surface bulk have a higher lithium to transition metal molar ratio. However, the lithium to transition metal molar ratio of the surface bulk of the invented particle is between 0.5 and 0.95 and the thickness of its surface bulk can range from a few to tens of nanometers.

In an embodiment of the invention, the average lithium to transition metal molar ratio of particle surface bulk is between 0.5 and 0.95. In another embodiment of the invention, the average lithium concentration of particle surface bulk is between 50 and 95 percent compared to the average lithium concentration of particle core bulk, (preferably 65 and 90 percent, and most preferably 80 to 95 percent). The molar ratio of lithium to the transition metals between the surface carbon layer and the primary particle core bulk (i.e., region) is less than 0.95 such that the particle comprises a lithium-deficient composition Li₁₊ₐ MPO₄ with −0.05≤a<0, and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

In an embodiment of the invention, the molar ratio of lithium to the transition metals between the surface carbon layer and the primary particle core bulk is less than 95 percent of the molar ratio of the primary particle core bulk so as to the primary particle has a lithium-deficient particle shell comprising component selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

The ratio of lithium to total transition metal decreases from the secondary particle core to the particle surface so as to comprise a lithium-deficient composition Li₁₊ₐMPO₄ with −0.05≤a<0, and M is selected from the group consisting of B, F, Na, Mg, Al, Si, Ca, Sc, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof. The ratio of lithium to total transition metal decreases from the particle core to the particle surface so as to comprise a lithium-deficient composition Li₁₊ₐNiₓCo_{y}Mn_{z}M_{w}O₂ with −0.05≤a<0, x+y+z+w=1, 0≤x≤1, 0≤y≤1, 0≤z≤1, 0≤w≤1, and M is selected from the group consisting of B, F, Na, Mg, Al, Si, Ca, Sc, S, Ti, V, Cr, Fe, Cu, Zn, Ga, Ge, Sr, Y, Zr, Nb, Mo, Ru, Ag, In, Sn, Sb, Ba, La, W, Ta, Bi, and combinations thereof.

In an embodiment of the invention the particle has at least two concentration changes of constituents from the particle core to the particle surface selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, and Bi.

Embodiments of the primary particle include components with gradual changes in concentration inside the particle, wherein the components are selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

Embodiments of the secondary particle may have disconnected component concentration changes within the particle. The electronic and ionic communication pathways inside the secondary particle are all connected to define a 3-dimensional nano-net carbon connection without disruption. The net comprises localized carbon layers of primary particles and wide-area carbon linkages of secondary particles (FIG. 9D). FIG. 9D shows carbon-layered primary particles with a size of 100˜300 nm, which are formed into secondary particle through the granulation process (with carbon linkages and CNT linkages). As shown in FIG. 9D, the thickness of these carbon linkages and CNT linkages is nano-scale (less than 1 micron), and their tangled diameter surrounding the primary particles is 1˜30 microns that is same as the diameter of the secondary particles (i.e., FIG. 9A, FIG. 9C, and FIG. 10C).

This carbon communication comprises surrounding primary particles (carbon layered by the invented hydrothermal process), penetrating the inside of primary particles (CNT-embedded by the invented hydrothermal process), connecting primary particles to form secondary particles (carbon-linked by granulation), surrounding secondary particles (carbon-linked by granulation), coursing through the secondary particle between its primary particles (CNT-linked by granulation), and a combination thereof.

The aforementioned carbon layers physically separate the metal components constituting each primary particle by carbon. Therefore, the connection of carbon inside the secondary particle is continuous as a 3-dimensional nano-net, but the metal components of each primary particle inside the secondary particle are disconnected by carbon.

In addition, by the invented hydrothermal process, primary particles can have internal metal concentration changes, and the resulting secondary particle can have metal component concentration changes of each primary particle separated by carbon. This is due to some primary single crystal particles having concentration gradients of metal components. Therefore, considering the secondary particle as a whole, its interior has the concentration change of the primary particle, but it is cut off by the carbon layers surrounding the primary particle. This yields a secondary particle with disconnected metal component concentration changes, wherein the components are selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property or privilege is claimed is defined as follows:

1. A cathode material comprising secondary particles each comprised of primary particles, wherein each of the primary particles has single crystal structure and carbon layers.

2. The cathode material as recited in claim 1 wherein a first concentration of lithium at a surface of the cathode material is less than a second concentration at a core of the cathode material.

3. The cathode material as recited in claim 1 wherein the carbon layers form 3-dimensional carbon layers of primary particles and carbon linkages of secondary particles serving as electronic and ionic communication pathways with adjacent primary particles.

4. The cathode material as recited in claim 1 wherein the carbon layers are comprised of individual carbon structures selected from the group consisting of carbon nanotubes, carbon nanofiber, graphene, graphite, microporous carbon, mesoporous carbon, nanoporous carbon, carbonaceous mortar, flexible conductive polymer, and combinations thereof so as to flexibly connect the primary particles.

5. The cathode material as recited in claim 1 wherein the primary particles have internal carbon layers and the primary particle has internal concentration changes of metal components selected from the group consisting of Li, B, F, Na, Mg, Al, Si, Ca, Sc, P, S, Ti, V, Cr, Mn, Fe, Co, Ni, Cu, Zn, Ga, Ge, Sr, Y, Zr, Nb, Mo, Ru, Ag, In, Sn, Sb, Ba, La, W, Ta, Bi, and combinations thereof.

6. The primary particle as recited in claim 5 wherein the internal carbon layers are in electronic communication with each other such that adjacent primary particles are in electronic and ionic communication with each other, and wherein primary particles form secondary particles having disconnected internal concentration changes of metal components.

7. The cathode material as recited in claim 1 wherein the carbon layers of individual primary particles combine to form electronic and ionic passages that have a tangled diameter of between 1 micron and 30 microns and thicknesses of between 0.001 microns and 1 micron.

8. The cathode material as recited in claim 1 wherein the average lithium to transition metal molar ratio of primary particle surface bulk is between 0.5 and 0.95.

9. The cathode material as recited in claim 1 wherein the average lithium concentration of particle surface bulk is between 50 and 95 percent of the lithium concentration of particle core bulk.

10. A method for preparing cathode material, the method comprising:
a) dissolving metal salts and carbon stock in water to create a metal containing solution;
b) mixing the solution with a lithium containing solution at a subcritical temperature of water to create a mixture of agglomerated particles;
c) allowing the mixture to reach a hydrothermal reaction condition for a time to form grain-free primary single crystal lithiated particles;
d) removing lithium proximal to the surface of the primary single crystal lithiated particles at subcritical temperatures and a supercritical pressure of water;
e) drying the primary single crystal partially de-lithiated particles; and
f) heat-treating the particles.

11. The method as recited in claim 10 wherein the mixing step occurs above the critical pressure of water.

12. The method as recited in claim 10 wherein the hydrothermal reaction condition comprises injecting the agglomerated solid particles into a main reactor together with a supercritical water so as to make a non-gradual thermal jump of the agglomerated solid particles from a subcritical temperature to a supercritical temperature of water.

13. The method as recited in claim 10 wherein simultaneous with removing lithium proximal to the particle surface, additional carbon-layer is formed on the surface of the single-crystal particles by mixing the single crystal particles with a carbon-containing aqueous solution.

14. The method as recited in claim 13 further comprising depositing metal components on the particle surface by mixing a carbon-containing aqueous solution containing metal salts below 100° C. and above the critical pressure of water; wherein the carbon-containing aqueous solution makes a non-gradual thermal sink of the single-crystal lithiated particles from a supercritical temperature to a subcritical temperature of water.

15. The method as recited in claim 10 wherein the hydrothermal reaction condition comprises a temperature ranging from 374° C. to 500° C. and a pressure ranging from 220 bar to 500 bar.

16. The method as recited in claim 10 wherein the agglomerated solid particles are exposed to a combination of laminar flow mixing, turbulent flow mixing, static in-line mixing, agitator mixing, sonication mixing, and combinations thereof below the critical temperature and above the critical pressure of water.

17. The method as recited in claim 12 wherein the supercritical water includes compounds selected from the group consisting of water, alcohol, oxidizing agent, reducing agent, carbon source, additives, and combinations thereof.

18. The method as recited in claim 10 wherein the drying step utilizes a granulation process is applied using a device selected from the group consisting of fluid-bed dryer, spray dryer, spheronizer, centrifugal rotator, pelletizer, crusher, particle size classifier and combinations thereof.

19. The method as recited in claim 18 wherein the step of utilizing a granulator device results in the formation of micron-sized secondary particles having internal carbon layers by connecting carbon source with the primary single-crystal partially de-lithiated particles.

20. The method as recited in claim 18 wherein the granulation forms a micron-sized secondary particle having three-dimensional, embedded internal carbon layers by connecting carbon source with the primary single-crystal partially de-lithiated particles each having three-dimensionally-embedded internal carbon layers.
